(19) United States
(12) Patent Application Publication
(10) Pub. No.: US 2025/0035943 A1
(43) Pub. Date: Jan. 30, 2025

(54) SOLAR POWERED ILLUMINATION FOR ETCHED RETICLES IN OPTICS

(71) Applicants: James Labita, Mesa, AZ (US); Francis M. Plumb, Issaquah, WA (US)

(72) Inventors: James Labita, Mesa, AZ (US); Francis M. Plumb, Issaquah, WA (US)

(21) Appl. No.: 18/781,860

(22) Filed: Jul. 23, 2024

Related U.S. Application Data
(60) Provisional application No. 63/529,642, filed on Jul. 28, 2023.

(51) Int. Cl. G02B 27/01; G02B 23/00

(52) U.S. Cl. CPC G02B 27/0189; G02B 23/00

(57) ABSTRACT

A solar powered optical scope is disclosed. In one embodiment, the solar powered optical scope includes an etched reticle with lines and markings that provide measurement references in a line of sight. The solar powered optical scope further includes a photovoltaic device with photovoltaic cells to convert sunlight into electricity to power or to supplement power used to illuminate the etched reticle.

### CROSS-REFERENCE TO RELATED APPLICATIONS

The present Application claims the benefit of U.S. Provisional Patent Application Ser. No. 63/529,642 filed on Jul. 28, 2023, the entire disclosure of which is incorporated herein in its entirety by reference.

### FIELD

This disclosure generally relates to solar powered illumination for etched reticles in optics.

### BACKGROUND

A scope is an optical device that is used to provide the user with an accurate aiming point. Scopes are generally classified according to the optical magnification of the scope. While some scopes are fixed magnification types, such as prism or non-variable magnifications scopes. Other scopes are variable magnification scopes, meaning that the magnification of the scope can be manipulated at any time. While scopes are generally used with a number of tools and systems, one of the most common uses for scopes is in connection with firearms, particularly rifles. While it is understood that the present invention may be used with any variable power optical device, including a telescope or night vision devices, examples herein may be given with respect to firearms. The aiming apparatuses are known as reticles or “Crosshairs”. Often to aid in quickly applying accurate shooting, a “Red Dot”, “Horseshoe”, or more complex arrangement of reference points is projected onto, or a part of the reticle. This illuminated element is very brightly lit or projected by a separate illumination source. This illuminated element of the reticle is normally laser etched into the internal glass components of the optical device. Within the etched area are reflective surfaces that provide the desired illuminated image. Normally this illumination source is fixed in relation to the reticle. So that the entire reticle, a portion thereof, or only the very center of the reticle is illuminated. Regardless of the internal positioning of the reticle, reticles are adjusted left and right or up and down to obtain accuracy. The illuminated aiming point is therefore always aligned with the center of the reticle. To date, the illumination source has exclusively been by powered by battery charge. However, the use of battery-powered illumination systems can be unreliable, inconvenient, and lack adequate power to illuminate the reticle during daytime use. The present invention overcomes these drawbacks by allowing for photovoltaic devices, commonly known as solar power panels, integrated into, or externally connected to the optic be the power source for the illumination method of etched reticles in optical devices.

The present invention is generally directed to an optical scope accessory, and more particularly the internal reticle apparatus. The optical device or scope normally comprises a main body, an optical system, an aiming point or reticle, and an illumination system. The present invention is integral to a fixed or variable power optical device. It uses photovoltaic cells, commonly known as solar panels, to convert sunlight into electricity. The electricity is used to directly, co-operatively, or passively to power a reticle illumination system. The illumination system of the present invention includes the photovoltaic device, an optional battery, a light projection source, and a control circuit. The current state of the art is to use a Light Emitting Diode (LED) to illuminate the aiming point or reticle. The photovoltaic device is generally located on the top surface of the optic, where it can receive sunlight. The battery stores or supplements the electrical energy generated by the photovoltaic device. The LED emits light that illuminates the reticle, which is typically laser etched on to glass internal to the optic. The control circuit regulates the charging of the battery and the activation of the LED.

### SUMMARY

A solar powered optical scope is disclosed. In one embodiment, the solar powered optical scope includes an etched reticle with lines and markings that provide measurement references in a line of sight. The solar powered optical scope further includes a photovoltaic device with photovoltaic cells to convert sunlight into electricity to power or to supplement power used to illuminate the etched reticle.

### BRIEF DESCRIPTION OF THE DRAWINGS

FIG. 1 is a side view of an optical device with an integrated photovoltaic device positioned in the optical device according to one exemplary embodiment.

FIG. 2 is a side view of an optical device with a photovoltaic device positioned in an external configuration on the optical device mount with a power supply to the optical device existing battery compartment according to one exemplary embodiment.

FIG. 3 is an angled view of components isolated without the optical device according to one exemplary embodiment.

FIG. 4 is a side cutaway view of an optical device with a photovoltaic device, a battery, and an illumination device to illuminate the optical device's reticle according to one exemplary embodiment.

### DETAILED DESCRIPTION

The present invention is generally directed to an optical device component, and more particularly to a scope internal aiming apparatus. The present invention allows for the powering and illumination of the internal aiming points of the scope with solar power. It is generally understood that the solar power apparatus of the present invention may be integral to a scope or alternatively, may be attached to an external scope mount or other device. Generally, in one embodiment, the present invention includes four primary components; a photovoltaic device, a battery, an illumination device, and a reflective surface. In this embodiment the photovoltaic device collects solar power. The battery stores and supplements power. The illumination mechanism, such as a light emitting diode or laser projector, emits light onto the reflective surface, etched in the shape of an aiming point or reticle, of a clear component within the user's line of sight. In another embodiment of the present invention, the battery, the photovoltaic devices, or both apparatuses may be external to the optical scope. Thus, the present invention can be manufactured as part of the optical device or may be retrofitted to existing optical devices to provide users with an improved and redundant powering process.

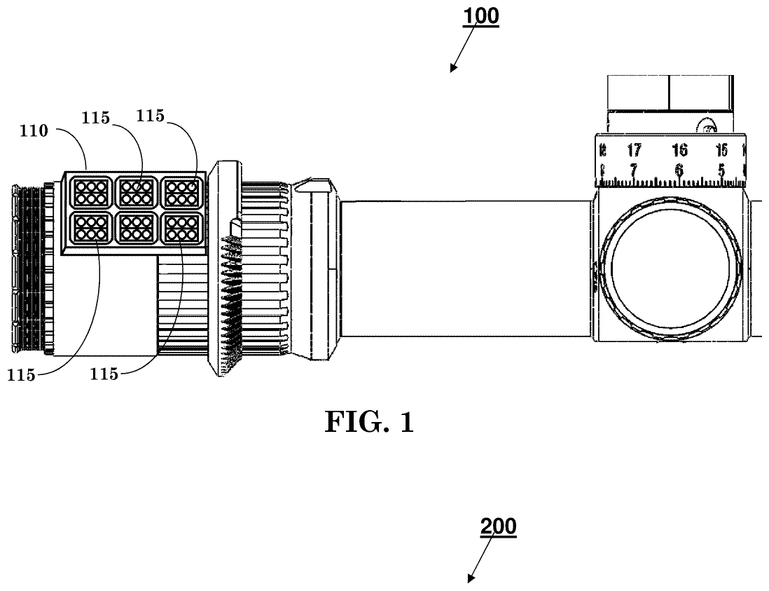

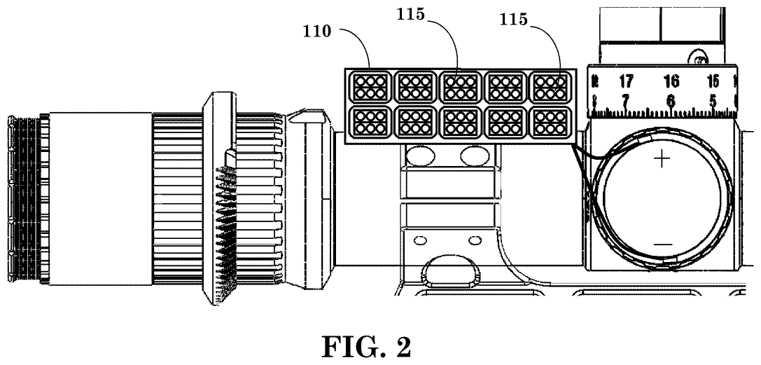

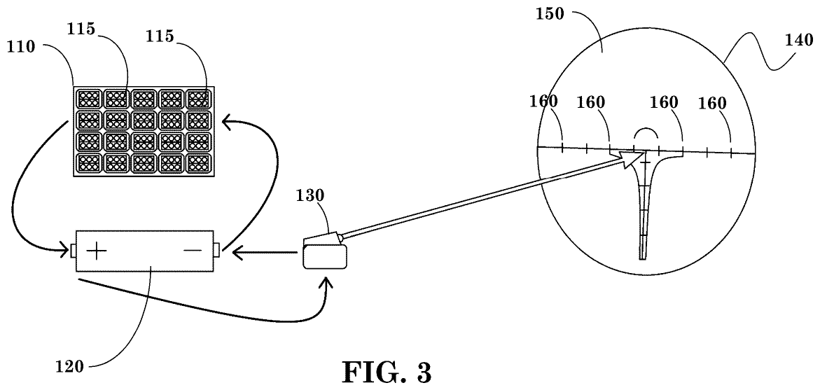

Turning to FIGS. 1-4, the present invention may be described in further detail. In one embodiment, the photovoltaic power mechanism consists of a photovoltaic device 110 that is permanently attached and integrated into an optical scope 100, as shown in FIG. 1. Alternatively, the photovoltaic device 110 may be externally or remotely attached to the optical device 200 and 400, as shown in FIGS. 2 and 3. Certain optical devices cannot be effectively retrofitted with internal or permanent modifications. In particular “Reflex” or “Red Dot” optics have external battery compartments that allow for a photovoltaic battery charger to be installed with minimal changes. An externally mounted photovoltaic apparatus for preexisting battery compartments of optical devices is more practical for retrofit applications. The photovoltaic device could be configured to attach to the existing battery compartment or power supply of an optical device to power or supplement the existing illumination of the optical device. The photovoltaic device could also be configured to attach to the existing battery compartment or power supply of an optical device to charge the existing battery of the optical device.

In one embodiment, the present invention includes a photovoltaic device 110 to power, or supplement power to illuminate etched reticles in optical devices. The photovoltaic device can be used to power the illumination of an entire reticle, a part of the reticle, or a specific aiming point within the reticle. The photovoltaic device could be integrated into the optic device body to illuminate etched reticles in optical devices (as shown in FIG. 1). The photovoltaic device could be externally placed on or separated placed from the optic device body to illuminate the etched reticle in the optical device (as shown in FIG. 2).

In general, a photovoltaic device 110 is a nonmechanical device with photovoltaic cells 115 that converts the energy of light directly into electricity by the photovoltaic effect. The photovoltaic device 110 has electrical characteristics, specifically electrical current and voltage, that increase when exposed to light. There are individual solar elements that are coupled together to become of the photovoltaic cells 115, and then collectively become the photovoltaic device 110 of the present invention. The operation of a photovoltaic cell 110 requires three general attributes. First, the absorption of light, generating excitons (bound electron-hole pairs), unbound electron-hole pairs (via excitons), or plasmons. Second, the separation of charge carriers of opposite types. Third, the separate extraction of those carriers to an external circuit, which is the transmission of the electric current for illumination.

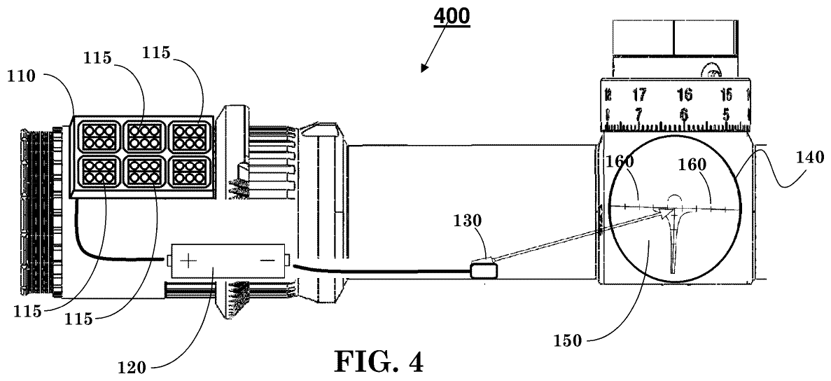

The present invention may or may not have a battery. FIGS. 3 and 4 illustrate exemplary embodiments with a battery 120. The battery 120 would be used to store collected energy, or supplement the direct energy from the photovoltaic device. It is possible for the photovoltaic device providing enough energy without a battery to simplistic optical devices. Most firearms related optical devices uses would require an internal or external battery component.

In one embodiment, a Light Emitting Diode (or laser projector) 130 would be calibrated to the internal reticle 140 of the scope 400. The LED could be a high-efficiency white LED, a LED of any other color, or a LED that project infra-red or ultra-violet light.

Variable power and fixed poser scopes have an internal aiming apparatus that is called a reticle 140. A reticle 140 consists of a pane 150 of crystal or glass that has etched marks (or line) 160 that represent aiming points. The LED (or laser projector) 130 would be calibrated to illuminate the entire reticle 140, a part of the reticle 140, or a specific aiming point on the reticle. The adjustments of the light or laser projector would be directly correlated to the adjustments for which the scope reticle is calibrated. This allows for proper function and for the external adjustment to the optical device to set the parameters of use.

The etched reticle 140 includes lines and markings 160 built into the optical device that provide measurement references in the line of sight of the user. There are many variations of reticle designs and production methods. The most common method is to use very precise lasers to physically engrave. The present invention is intended to incorporate current designs and methods of production. The present design is also intended incorporate illumination of future designs and production methods that require any modifications to a plane of glass, or other material, in the line of sight of the user, that has an embedded, etched, coated, composite, assembled, printed, attached, or in any other way provides an image for use in calibrating the image as a point of reference.

In one embodiment, the optical scope 100, 200, and 400 may include a microcontroller for monitoring the charging of the battery and the activation of the illumination of the etched reticle 140. The optical scope 100, 200, and 400 includes a switch for manual activation of the illumination of the reticle 140.

In one embodiment, the components of the present invention may be made of alloy, or may alternatively be made of other durable materials. In addition, the present invention may either be an add-on product to existing optical devices or a stock product with optical devices.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and sub combinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A solar powered optical scope, comprising:
an etched reticle with lines and markings that provide measurement references in a line of sight; and
a photovoltaic device with photovoltaic cells to convert sunlight into electricity to power or to supplement power used to illuminate the etched reticle.

2. The solar powered optical scope of claim 1, wherein the photovoltaic cells are used to convert sunlight into electricity to power or to supplement power used to illuminate the entire etched reticle, a part of the etched reticle, or a specific aiming point within the etched reticle.

3. The solar powered optical scope of claim 1, wherein the photovoltaic device with photovoltaic cells is integrated into a body of the solar powered optical scope to generate power to illuminate the etched reticle.

4. The solar powered optical scope of claim 1, wherein the photovoltaic device with photovoltaic cells is external to the solar powered optical scope and is operative coupled to the solar powered optical scope to generate power to illuminate the etched reticle.

5. The solar powered optical scope of claim 4, wherein the photovoltaic device with photovoltaic cells is operative coupled to an existing battery compartment or a power supply of the solar powered optical scope to generate power to illuminate the etched reticle.

6. The solar powered optical scope of claim 4, wherein the photovoltaic device with photovoltaic cells is operative coupled to an existing battery compartment or a power supply of the solar powered optical scope to charge a battery of the solar powered optical scope.

7. The solar powered optical scope of claim 6, further comprises:
a microcontroller for monitoring charging of the battery and activation of illumination of the etched reticle.

8. The solar powered optical scope of claim 1, further comprises:
a light-emitting diode (LED) used to illuminate the etched reticle, wherein the LED is a high-efficiency white LED, a color LED, or a LED that projects infra-red of ultra-violet light.

9. The solar powered optical scope of claim 1, further comprises:
a switch used to activate illumination of the etched reticle.
